(19) United States
(12) Patent Application Publication
(10) Pub. No.: US 2026/0193075 A1
(43) Pub. Date: Jul. 9, 2026

(54) FULLY CUSTOMIZABLE POWDER DISPENSING PLATFORM

(71) Applicant: THE COCA-COLA COMPANY, Atlanta, GA (US)

(72) Inventors: Andrew KOLPITCKE, Atlanta, GA (US); Joshua Allen INGRAM, Atlanta, GA (US)

(21) Appl. No.: 19/136,154

(22) PCT Filed: Nov. 3, 2023
(86) PCT No.: PCT/US2023/036755

§ 371 Date: Jun. 5, 2025

Related U.S. Application Data
(60) Provisional application No. 63/386,928, filed on Dec. 12, 2022.

(51) Int. Cl. B67D 1/00

(52) U.S. Cl. CPC B67D 1/0051

(57) ABSTRACT

The present application provides a beverage dispensing system for dispensing a beverage with a powder ingredient. The beverage dispensing system may include a powder hopper with the powder ingredient therein, a mixing bowl for mixing the powder ingredient and a flow of water into a blended powder solution, a nozzle, and a pump to pump to blended powder solution from the mixing bowl to the nozzle.

### CROSS-REFERENCE TO RELATED APPLICATIONS

This application claims priority to and benefit of U.S. provisional patent application No. 63/386,928, filed Dec. 12, 2022, which is herein incorporated by reference.

### TECHNICAL FIELD

The present application and the resultant patent relate generally to beverage dispensers and more particularly relate to beverage dispensers equipped to meter, mix, and dissolve various types of powder ingredients into a beverage stream for dispensing therefrom.

### BACKGROUND OF THE INVENTION

Recent improvements in beverage dispensing technology have focused on the use of micro-ingredients. With micro-ingredients, traditional beverage bases may be separated into their constituent parts at much higher dilution or reconstitution ratios. For example, the “COCA-COLA FREESTYLE®” refrigerated beverage dispensing units offered by The Coca-Cola Company of Atlanta, Georgia provide a significant increase in the number and types of beverages that may be offered by a beverage dispenser of a conventional size or footprint. Generally described, the “COCA-COLA FREESTYLE®” refrigerated beverage dispensing units create a beverage by combining a number of highly concentrated micro-ingredients with a macro-ingredient such as a sweetener and a diluent such as still or carbonated water. The micro-ingredients generally are stored in cartridges positioned within or adjacent to the beverage dispenser itself. The number and type of beverages offered by the beverage dispenser thus may be limited only by the number and type of micro-ingredient cartridges positioned therein.

There is an increasing focus for some consumers in the category of Health & Wellness. This category may include vitamins, minerals, nutraceuticals, proteins, other types of supplements, and the like. Current beverage dispense dispensing technology generally only provides for the reliable delivery of liquid ingredients. Powder ingredients may present challenges for dispensing in the context of typical liquid dispensing technology because these powder ingredients may not mix well, may not be sufficiently shelf-stable, and/or may lose their efficacy when dissolved in a liquid. This is particularly true for cold beverages. There is thus a desire for improved beverage dispensing systems and the like that can accommodate the dispensing of powder ingredients in a safe and efficient manner.

### SUMMARY OF THE INVENTION

The present application and the resultant patent thus provide a beverage dispensing system for dispensing a beverage with a powder ingredient. The beverage dispensing system may include a powder hopper with the powder ingredient therein, a mixing bowl for mixing the powder ingredient and a flow of water into a blended powder solution, a nozzle, and a pump to pump to blended powder solution from the mixing bowl to the nozzle.

The present application and the resultant patent further may provide a method of preparing a beverage with a powder ingredient therein. The method may include the steps of dosing the powder ingredient into a mixing bowl, flowing water into the mixing bowl, flowing the powder ingredient and the water to a blending chamber, mixing the powder ingredient and the water into a blending powder solution, and pumping the blended powder solution to a nozzle.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an exemplary beverage dispensing system.

FIG. 2 is a perspective view of an exemplary beverage dispensing system with a powder dispensing system as may be described herein.

FIG. 3 is sectional view of a powder hopper for use with the powder dispensing system of FIG. 2.

FIG. 4 is partial sectional view of the powder dispensing system of FIG. 2 showing powder hoppers, a mixing bowl, a blending chamber, a blending motor, and a nozzle.

FIG. 5 is a perspective view of a pump for use with the powder dispensing system of FIG. 2.

FIG. 6 is a flow chart showing exemplary dispensing steps of the powder dispensing system of FIG. 2.

### DETAILED DESCRIPTION

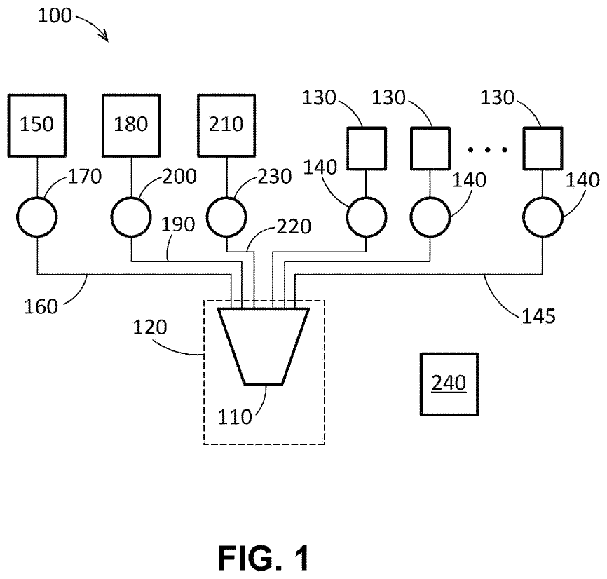

Referring now to the drawings, in which like numerals refer to like elements throughout the several views, FIG. 1 shows an example of a beverage dispensing system 100 as may be described herein. The beverage dispensing system 100 may be used for dispensing many different types of beverages. Specifically, the beverage dispensing system 100 may be used with diluents, macro-ingredients, micro-ingredients, and other types of fluids and ingredients such as powders. The diluents generally include plain water (still water or non-carbonated water), carbonated water, and other fluids. Any type of fluid may be used herein.

Generally described, the macro-ingredients may have reconstitution ratios in the range from full strength (no dilution) to about six (6) to one (1) (but generally less than about ten (10) to one (1)). The macro-ingredients may include sugar syrup, HFCS (“High Fructose Corn Syrup”), concentrated extracts, purees, and similar types of ingredients. Other ingredients may include dairy products, soy, and rice concentrates. Similarly, a macro-ingredient base product may include the sweetener as well as flavorings, acids, and other common components as a beverage syrup. The beverage syrup with sugar, HFCS, or other macro-ingredient base products generally may be stored in a conventional bag-in-box container remote from the beverage dispenser. The viscosity of the macro-ingredients may range from about 1 to about 10,000 centipoise and generally over 100 centipoises when chilled. Other types of macro-ingredients and the like may be used herein.

The micro-ingredients may have reconstitution ratios ranging from about ten (10) to one (1) and higher. Specifically, many micro-ingredients may have reconstitution ratios in the range of about 20:1, to 50:1, to 100:1, to 300:1, or higher. The viscosities of the micro-ingredients typically range from about one (1) to about six (6) centipoise or so, but may vary from this range. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutraceuticals; and over the counter (or otherwise) medicines such as turmeric, acetaminophen; and similar types of ingredients. Various types of alcohols may be used as either macro-ingredients or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

The various fluids used herein may be mixed in or about a dispensing nozzle 110. The dispensing nozzle 110 may be a conventional multi-flavor nozzle and the like. The dispensing nozzle 110 may have any suitable size, shape, or configuration. The dispensing nozzle 110 may be positioned within a dispensing tower 120. The dispensing tower 120 made have any suitable size, shape, or configuration. The dispensing tower 120 may extend from a countertop and the like and/or the dispensing tower 120 may be a free-standing structure. The dispensing tower 120 may have a number of the dispensing nozzles 110 thereon.

The micro-ingredients may be stored in a number of micro-ingredient containers 130 or other types of micro-ingredient sources. The micro-ingredient containers 130 may have any suitable size, shape, or configuration. Any number of the micro-ingredient containers 130 may be used herein. The micro-ingredient containers 130 may be in communication with the dispensing nozzle 110 via a number of micro-ingredient pumps 140 positioned on a number of micro-ingredient conduits 145. The micro-ingredient pumps 140 may be any type of a conventional fluid moving device and made have any suitable volume or capacity. The micro-ingredient containers 130 may be positioned in, adjacent to, and/or remote from the dispensing nozzle 110. For example, the micro-ingredient containers 130 may be positioned under the counter top upon which the dispensing tower 120 rests. Some or all of the micro-ingredient containers 130 may be agitated.

A still water source 150 may be in communication with the dispensing nozzle 110 via a still water conduit 160. Other types of diluents may be used herein. Still water or other types of diluents may be pumped to the dispensing nozzle 110 via a still water pump 170. The still water pump 170 may be may be any type of conventional fluid moving device and made have any suitable volume or capacity. Alternatively, the pressure in a conventional municipal water source may be sufficient without the use of a pump. Any number of still water sources 150 may be used herein.

A carbonated water source 180 may be in communication with the dispensing nozzle 110 via a carbonated water conduit 190. The carbonated water source 180 may be a conventional carbonator and the like. The carbonator may have any suitable size, shape, or configuration. Carbonated water or other types of diluents may be pumped to the dispensing nozzle 110 via a carbonated water pump 200. The carbonated water pump 200 may be any type of conventional fluid moving device and made have any suitable volume or capacity. Any number of carbonated water sources 180 may be used herein. A carbonated water recirculation line also may be used herein.

One or more macro-ingredient sources 210 may be in communication with the dispensing nozzle 110 via one or more macro-ingredient conduits 220. As described above, the macro-ingredient sources 210 may include sweeteners such as high fructose corn syrup, sugar solutions, and the like. The macro-ingredient sources 210 may be a conventional bag-in-box or other type of container in any suitable size, shape, or configuration. Any number of the macro-ingredient sources 210 may be used herein. The macro-ingredients may flow to the dispensing nozzle 110 via a macro-ingredient pump 230. In this case, the macro-ingredient pump 230 may be a controlled gear pump and the like. Other types of pumps or conventional fluid moving devices may be used herein.

Operation of the beverage dispensing system 100 and the component therein may be controlled by a control device 240. The control device 240 may be a conventional microcomputer and the like capable of executing programmable commands. The control device 240 may be internal or external from the beverage dispensing system 100. The functionality of the control device 240 may be implemented in software, firmware, hardware, or any combination thereof. One control device 240 may control multiple beverage dispensing systems 100 and/or one beverage dispensing system 100 may have multiple control devices 240 with specific tasks. Other components and other configurations may be used herein.

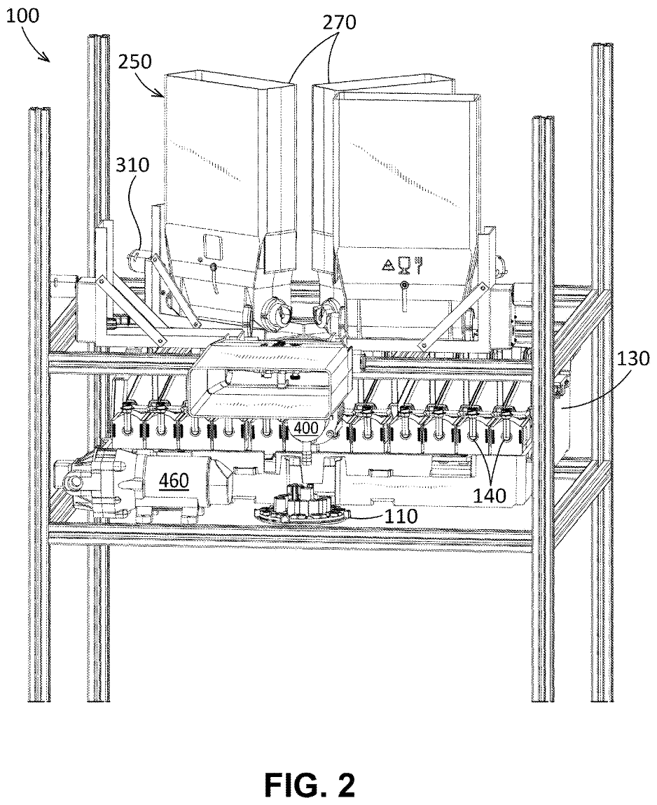

FIG. 2 shows a further embodiment of the beverage dispensing system 100. In addition to the nozzle 110, the micro-ingredient containers 130, the water sources 150, 180, the macro-ingredient source 210, and the respective conduits and pumps, the beverage dispensing system 100 also includes a powder dispensing system 250. The powder dispensing system 250 may be used to dispense any type of a powder ingredient 260, i.e., a substantially dry, flowable, fine granular substance and the like. As described above, examples include, but are not limited to, vitamins, minerals, nutraceuticals, proteins, other types of supplements, and the like. The powder ingredient 260 may be a micro-ingredient or a macro-ingredient. Any food grade flowable substance may be used herein.

The powder dispensing system 250 may include a number of powder hoppers 270 with a volume of the powder ingredient 260 therein. The powder hoppers 270 may have any suitable size, shape, and configuration. The powder hoppers 270 may be made out of, for example, food grade thermoplastics, or any type of substantially rigid materials or composites thereof. In this example, the powder dispensing system 250 may accommodate five powder hoppers 270 as is shown, although any number of the powder hoppers 270 may be used.

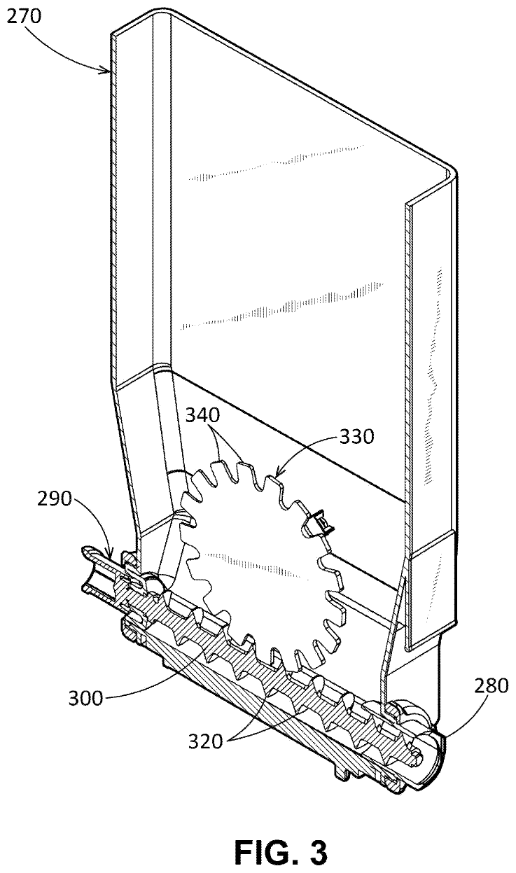

As is shown in FIG. 3, the powder hoppers 270 may have an orifice 280 at a bottom end thereof. The orifice 280 may be in communication with an auger/screw mechanism 290. The auger/screw mechanism 290 may have an auger 300 driven by an auger motor 310. The auger 300 may be of conventional design and may include a number of screw threads 320 to push the powder ingredient 260 towards the orifice 280. The auger motor 310 may be a conventional DC motor and the like. The auger motor 310 may have a rotary decoder attached thereto so as to measure precisely the amount of powder dispensed per revolution of the auger motor 310 so as to control the amount of the powder ingredient 260 being dispensed. The auger motor 310 may be in communication with the control device 240. The auger/screw mechanism 290 also may include an internal gear wheel 330 to ensure that the powder ingredient 260 therein is flowable. The gear wheel 330 may have a number of gear teeth 340 that cooperate with the screw threads 320 of the auger 300 so as to rotate the gear wheel 330 and keep the powder ingredient 260 flowing. Other types of metering devices may be used herein. Other components and other configurations may be used herein.

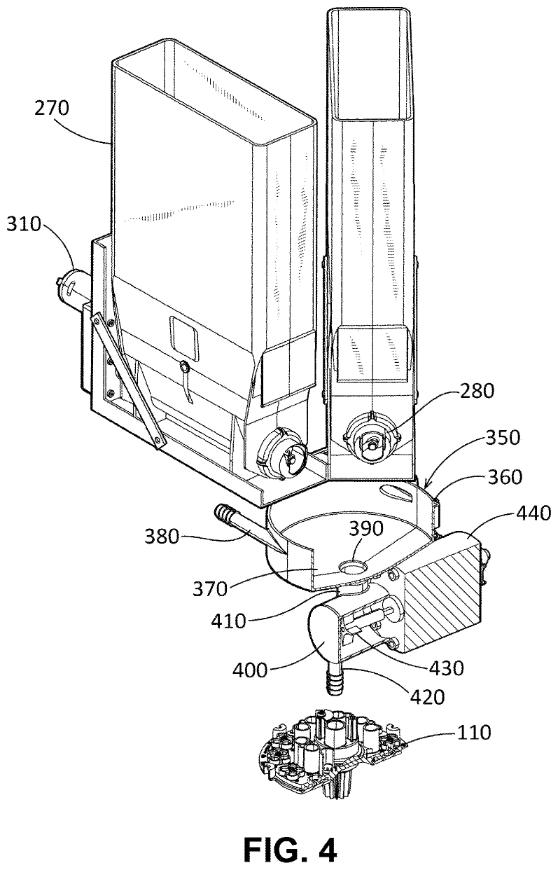

As is shown in FIG. 4, the powder dispensing system 250 may include a mixing bowl 350 positioned adjacent to the powder hoppers 270. The mixing bowl 350 may be largely circular in shape with a raised rim 360 and a concave floor 370. The raised rim 360 may have a number of water ports 380 therein. The water ports 380 may be in communication with the still water source 150 or other type of water source to provide a swirl of water 385 therein. A metering device may be used therewith. The concave floor 370 may include a central drain 390 therein. The powder ingredient 260 from the powder hoppers 270 may begin to mix with the flow of water 385 as the water exits the water ports 380 and circulates about the raised rim 360 and the concave floor 370. The mixing bowl 350 may have any suitable size, shape, or configuration. Other components and other configurations may be used herein.

The powder dispensing system 250 may include a blending chamber 400 position beneath the mixing bowl 350. The blending chamber 400 may have an entrance port 410 and an exit port 420. The entrance port 410 may be in communication with the central drain 390 of the mixing bowl 350. The blending chamber 400 may include a blending impeller 430 positioned therein. The blending impeller 430 may be driven by a impeller motor 440. The blending motor 440 may be a conventional DC motor and the like. The impeller motor 440 may be in communication with the control device 240. The partially blended powder ingredient 260 and the flow of water 385 from the mixing bowl 350 may be fully blended in the blending chamber 400 via the blending impeller 430 such that a blended powder solution 450 may leave the exit port 420. The blending chamber 400 may have any suitable size, shape, or configuration. Other components and other configurations may be used herein.

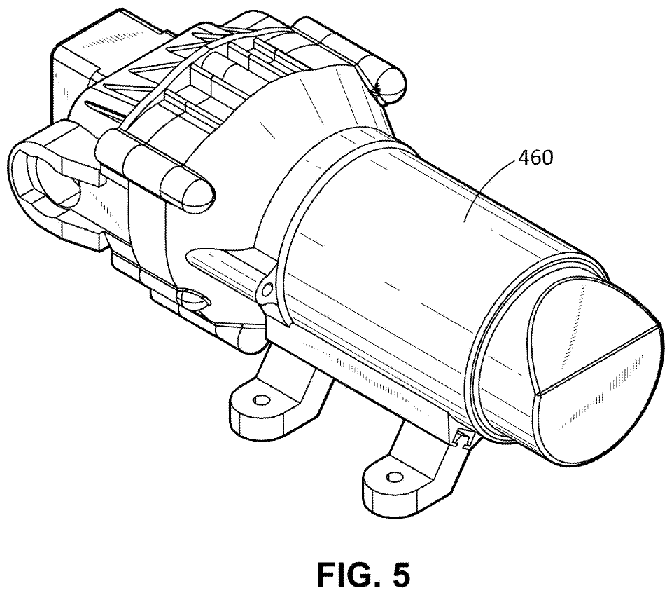

As is shown in FIG. 5, the powder dispensing system 250 may include a booster pump 460. The booster pump 460 may be a conventional diaphragm pump and the like. The booster pump 460 may be positioned between the blending chamber 400 and the nozzle 110. The velocity of the somewhat viscous blended powder solution 450 leaving the blending chamber 400 may be insufficient to flow to the nozzle 110 via gravity alone. The booster pump 460 thus ensures a consistent flow rate of the blended powder solution 450 to the nozzle 110. The booster pump 460 may have any suitable size, shape, or configuration. Other components and other configurations may be used herein.

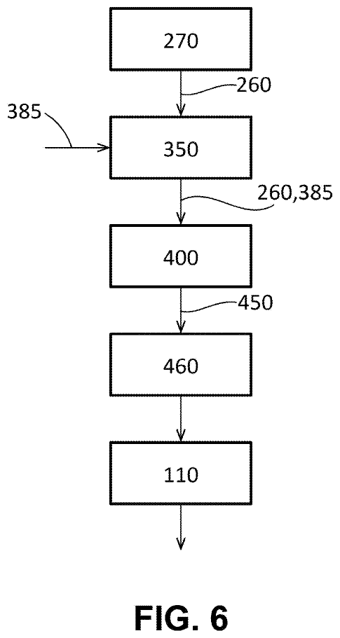

In use as is shown in FIG. 6, a consumer requests a beverage and/or a beverage with additives at the beverage dispensing system 100. The control device 240 determines the recipe and initiates the dispense of the beverage. In addition to dispensing the micro-ingredients, the macro-ingredients, and diluents, the control device 240 also initiates the dispense of a predetermined volume of one or more of the powder ingredients 260. Specifically, the control device 240 initiates the operation of the auger motor 310 such that the auger 300 dispenses the predetermined volume of the powder ingredient 260 from one or more of the powder hoppers 270 to the mixing bowl 350. The control device 240 likewise initiates a flow of water 385 from the water source 150 to the mixing bowl 350 via the water ports 380. The water 385 may prewash the mixing bowl 350 to prevent any of the powder ingredient 260 from sticking thereon.

The powder ingredient 260 and the flow of water 385 begin to mix in the mixing bowl 350 and flow into the blending chamber 400. The control device 240 turns on the impeller motor 440 therein to further mix the powder ingredient 260 and the flow of water 385 into the blended powder solution 450. The somewhat viscous blended powder solution 450 then may be pumped to the nozzle 110 via the booster pump 460. The blended powder solution 450 may be dispensed from the nozzle 110 and mixed with the flow of the beverage therein. The control device 240 then may initiate a water rinse to eliminate any powder residue or carry over. Other and different dispensing steps may be used herein in any order or combination.

The powder dispensing system 250 thus accurately and safely dispenses doses of one or more of the powder ingredients 260 to the nozzle 110. The powder dispensing system 250 may be compatible with existing macro-ingredients (such as bag-in-box sweeteners) and micro-ingredients to produce an enhanced core brand and/or flavored beverages. Specifically, the powder dispensing system 250 may provide vitamins, minerals, nutraceuticals, proteins, other types of supplements, and the like in a conventional beverage dispensing system.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A beverage dispensing system for dispensing a beverage with a powder ingredient, comprising:
a powder hopper with the powder ingredient therein;
a mixing bowl for mixing the powder ingredient and a flow of water into a blended powder solution;
a nozzle; and
a pump to pump to blended powder solution from the mixing bowl to the nozzle.

2. The beverage dispensing system of claim 1, further comprising a blending chamber.

3. The beverage dispensing system of claim 2, wherein the blending chamber comprises an impeller therein.

4. The beverage dispensing system of claim 3, wherein the impeller comprises an impeller motor.

5. The beverage dispensing system of claim 2, wherein the blending chamber is positioned between the mixing bowl and the pump.

6. The beverage dispensing system of claim 1, wherein the powder hopper comprises an auger therein.

7. The beverage dispensing system of claim 6, wherein the auger comprises an auger motor.

8. The beverage dispensing system of claim 6, wherein the powder hopper comprises a gear wheel therein.

9. The beverage dispensing system of claim 1, further comprising a plurality of powder hoppers positioned about the mixing bowl.

10. The beverage dispensing system of claim 1, wherein the mixing bowl comprises one or more water ports.

11. The beverage dispensing system of claim 1, wherein the mixing bowl comprises a concave floor.

12. The beverage dispensing system of claim 1, wherein the pump comprises a booster pump.

13. The beverage dispensing system of claim 1, further comprising a plurality of micro-ingredient containers with micro-ingredients therein in communication with the nozzle.

14. The beverage dispensing system of claim 1, further comprising a macro-ingredient source with a macro-ingredient therein in communication with the nozzle.

15. A method of preparing a beverage with a powder ingredient therein, comprising:
dosing the powder ingredient into a mixing bowl;
flowing water into the mixing bowl;
flowing the powder ingredient and the water to a blending chamber;
mixing the powder ingredient and the water into a blending powder solution; and
pumping the blended powder solution to a nozzle.
